(19) United States
(12) Patent Application Publication
(10) Pub. No.: US 2014/0155220 A1
(43) Pub. Date: Jun. 5, 2014

(54) Drivetrain Provided with a CVT

(71) Applicants: Francois Messier, Varennes (CA); Jean-Francois Dionne, Saint-Hurbert (CA); Samuel Beaudoin, Yamaska (CA)

(72) Inventors: Francois Messier, Varennes (CA); Jean-Francois Dionne, Saint-Hurbert (CA); Samuel Beaudoin, Yamaska (CA)

(73) Assignee: Transmission CVTCORP Inc., SAINTE-JULIE, QC (CA)

(21) Appl. No.: 14/112,728

(22) PCT Filed: Mar. 26, 2012
(86) PCT No.: PCT/CA12/00274

§ 371 Date: Dec. 5, 2013

Related U.S. Application Data
(60) Provisional application No. 61/480,126, filed on Apr. 28, 2011.

(51) Int. Cl. F16H 37/02

(52) U.S. Cl. CPC F16H 37/022
USPC 476/33

(57) ABSTRACT

A drivetrain provided with a CVT that can be used in both CVT and Infinitely Variable Transmission (IVT) configurations and that includes a high-low gear selection assembly and a power mixer is described herein. The drivetrain includes a high-low gear selection mechanism that provides, in combination with the CVT, high and low ranges of gear ratios. The drivetrain further includes a power-mixer that allows the IVT configuration for transitions between high and low configurations that are seamless to the operator.

### FIELD

The present disclosure generally relates to vehicle drivetrains. More specifically, the present disclosure is concerned with a drivetrain provided with a Continuously Variable Transmission (CVT).

### BACKGROUND

CVTs are well known transmission mechanisms that can change trough an infinite number of gear rations. Toroidal CVTs, which are also well known, include discs and roller arrangements that transmit power between the discs, wherein one disc having a toroidal surface is the input and the other disc having a facing toroidal surface is the output. Such a transmission is used when transmission ratios have to be finely adjusted.

However, the ratio range required on a vehicle is often such that the size required for a CVT to cover the entire ratio range would be so large that it would be impractical to position it in some vehicle.

### SUMMARY

An object of illustrated embodiments is generally to provide an improved drivetrain including a CVT.

In accordance with an illustrative embodiment, there is provided a drivetrain a for connection to the output of a prime mover and to the input of a final drive therebetween; the drivetrain comprising:

a CVT (Continuous Variable Transmission) including an input disk coupled to the output of the prime mover and an output disk; the CVT being adapted to provide between the input and output thereof a primary continuous range of gear ratios;

a high-low gear selection mechanism having an input coupled to the output disk of the CVT and an output coupled to the input of the final drive; the high-low gear selection mechanism being adapted to selectively provide, in cooperation with the CVT, one of low and high continuous ranges of gear ratios between the output of the prime mover and the input of the final drive; the low continuous range of gear ratio ranging between minimum and maximum low gear ratios; the high continuous range of gear ratio ranging between minimum and maximum high gear ratios; and

a power mixer having a first input coupled to the output of the prime mover, a second input coupled to the output disk of the CVT and an output coupled to the input of the final drive; the power mixer being adapted to provide, in cooperation with the CVT, a continuous mixed gear ratio ranging between the maximum low gear ratio and the minimum high gear ratio between the output of the prime mover and the input of the final drive.

Other objects, advantages and features of the drivetrain will become more apparent upon reading the following non restrictive description of illustrated embodiments thereof, given by way of example only with reference to the accompanying drawings.

### BRIEF DESCRIPTION OF THE DRAWINGS

In the appended drawings:

FIG. 1 is a schematic bloc diagram of a drivetrain including a CVT according to a first illustrative embodiment;

FIG. 2 is a schematic bloc diagram of the drivetrain of FIG. 1 shown in a CVT low configuration;

FIG. 3 is a schematic bloc diagram of the drivetrain of FIG. 1 shown at the maximal speed of the CVT low configuration;

FIG. 4 is a schematic bloc diagram of the drivetrain of FIG. 1 shown in an IVT configuration;

FIG. 5 is a schematic bloc diagram of the drivetrain of FIG. 1 shown at the maximal speed of the IVT configuration;

FIG. 6 is a schematic bloc diagram of the drivetrain of FIG. 1 shown in a CVT high configuration;

FIG. 7 is a schematic bloc diagram of the drivetrain of FIG. 1 shown at the maximal speed of the CVT high configuration;

FIG. 8 is a schematic bloc diagram of the drivetrain of FIG. 1 shown in a reverse mode of the CVT configuration;

FIG. 9 is a schematic bloc diagram of a drivetrain including a CVT according to a second illustrative embodiment;

FIG. 10 is a schematic bloc diagram of the drivetrain of FIG. 9 shown in a CVT low configuration;

FIG. 11 is a schematic bloc diagram of the drivetrain of FIG. 9 shown at the maximal speed of the CVT low configuration;

FIG. 12 is a schematic bloc diagram of the drivetrain of FIG. 9 shown in an IVT configuration;

FIG. 13 is a schematic bloc diagram of the drivetrain of FIG. 9 shown at the maximal speed of the IVT configuration;

FIG. 14 is a schematic bloc diagram of the drivetrain of FIG. 9 shown in a CVT high configuration;

FIG. 15 is a schematic bloc diagram of the drivetrain of FIG. 9 shown at the maximal speed of the CVT high configuration; and

FIG. 16 is a schematic bloc diagram of the drivetrain of FIG. 9 shown in a reverse mode of the CVT configuration.

### DETAILED DESCRIPTION

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

It is to be noted that the expression “prime mover” is to be construed herein and in the appended claims as an internal combustion engine a turbine engine, or any other mechanical power production element or assembly.

It is to be noted that while the expression “CVT”, standing for Continuously Variable Transmission, is used herein to describe a dual-cavity full toroidal CVT, this expression is to be construed herein and in the appended claims as any type of CVT such as, for example, half-toroidal CVT and single cavity toroidal CVT.

It is to be noted that the expression “overdrive” when used herein in the context of a CVT, is to be construed herein and in the appended claims as a condition where the CVT ratio is such that the CVT output speed is higher than the CVT input speed.

It is to be noted that the expression “underdrive” when used herein in the context of a CVT, is to be construed herein and in the appended claims as a condition where the CVT ratio is such that the CVT output speed is lower than the CVT input speed.

It is to be noted that the term “drivetrain”, used herein and in the appended claims, are to be construed as the intervening mechanism by which power is transmitted from a prime mover to a final drive as well as this mechanism plus the prime mover.

It will also be noted that the expressions “fixed disk”, when used herein and in the appended claims in the context of clutch technology, may be viewed as any element or group of elements constituting a clutch driving member. Similarly, the expressions “movable disk”, when used herein and in the appended claims in the context of clutch technology, may be viewed as any element or group of elements constituting a clutch driven member.

The expression “power downstream” and “downstream” should both be construed, herein and in the appended claims, as meaning that an element is positioned further away from a power source, such as a prime mover, relatively to another element. Similarly, the expressions “power upstream” and “upstream” should be construed as meaning that an element is positioned nearer a power source, relatively to another element.

The expressions “connected” and “coupled” are interchangeable and should be construed herein and in the appended claims broadly so as to include any cooperative or passive association between mechanical parts or components. For example, such parts may be assembled together by direct coupling or connection, or indirectly coupled or connected using further parts. The coupling and connection can also be remote, using for example a magnetic field or else.

The expression “input”, without reference to a specific component such as a shaft, should be construed herein and in the appended claims, as including any movable part of an object, an assembly, a system or a mechanism that is used to receive a mechanical work from same or from another assembly, system or mechanism. Similarly, the expression “output” should be construed as including a similar part that is used to transfer a mechanical work.

The expression “gear ratio” should be construed herein and in the appended claims broadly as meaning the ratio between the speed of rotation at the input of a machine, system or assembly to that of the output thereof.

Other objects, advantages and features will become more apparent upon reading of the following non-restrictive description of illustrative embodiments thereof, given by way of example only with reference to the accompanying drawings.

Generally stated, the present disclosure is concerned with a drivetrain provided with a CVT that can be used in both CVT and Infinitely Variable Transmission (IVT) configurations and that includes low and high gear configurations. Transitions between configurations are seamless to the operator.

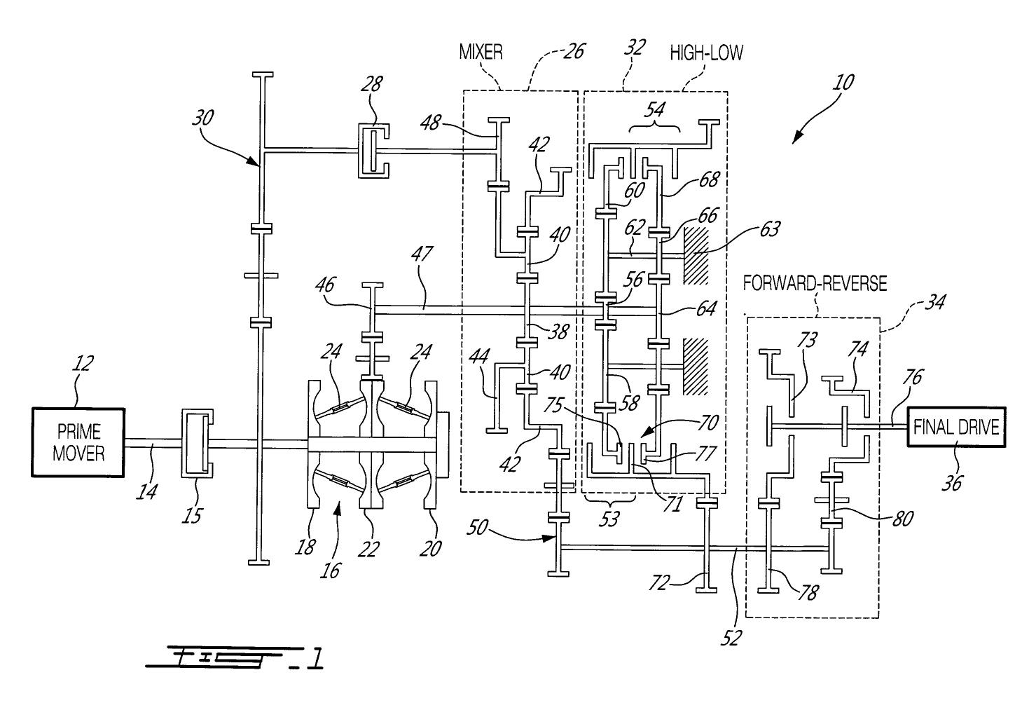

Turning now to FIG. 1 of the appended drawings, a drivetrain 10 according to a first illustrative embodiment will be described.

The drivetrain 10 includes a prime mover 12 provided with an output shaft 14 and a dual-cavity toroidal CVT 16 having two interconnected input disks 18 and 20 connected to the prime mover 12 via a first clutch 15, an output disk 22 and six rollers 24 (only four shown) provided between the output disk 22 and the input disks 18 and 20.

The drivetrain 10 further includes a power mixer 26 coupled both i) to the first clutch 15 via a second clutch 28 and a gear set 30 and ii) to the output disk 22 of the CVT 16; a high-low gear selection mechanism 32 also coupled to the output disk 22 of the CVT 16; a forward-reverse gear selection mechanism 34 coupled to both high-low gear selection mechanism 32 and to the power mixer 26 downstream therefrom and a final drive 36 coupled to the forward-reverse gear selection mechanism 34.

Each of these components of the drivetrain 10 will now be described in more detail.

As mentioned hereinabove, the dual-cavity toroidal CVT 16 is provided with two interconnected input disks 18 and 20; an output disk 22 and six rollers 24 (only four shown) provided between the output disk 22 and the input disks 18 and 20.

The CVT 16 is adapted to provide a continuous primary range of gear ratios between its input and output. The gear ratios provided by the CVT 16 and that can be selected to act on the output shaft 14 of the prime mover 12 range between a minimum primary gear ratio and a maximum primary gear ratio.

It is to be noted that since the operation of a toroidal CVT is believed to be known to one skilled in the art, it will not be explained herein, for concision purpose.

The input disks 18 and 20 are connected to the output shaft 14 of the prime mover 12 via the clutch 15.

The high-low gear selection mechanism 32 includes two planetary gear trains 53 and 54 for either one of respectively low and high gear set.

The mechanism 32 uses the CVT output as input to provide a selected one of low and high continuous ranges of gear ratios between the output of the prime mover 12 and the output of the high-low gear selection mechanism 32. The low continuous range of gear ratios ranging between minimum and maximum low gear ratios and the high continuous range of gear ratio ranging between minimum and maximum high gear ratios.

The first planetary gear train 53 includes first sun gear 56, first planet gears 58, a first ring gear 60, and a planet carrier 62. The second planetary gear train includes second sun gear 64, second planet gears 66 and a second ring gear 68. The second planetary gear 54 train shares the planet carrier 62 with the first planetary gear train 53. The planet carrier 62 is prevented from rotating by a connection to the casing 63.

The first and second sun gears 56 and 64 acts as an input of the mechanism 32 and as such is connected to the output disk 22 of the CVT 16 via a gear set 46 and a shaft 47.

A clutch assembly, including a three-position clutch 70 and a gear set 72 is provided between both the first and second ring gears 60 and 68 and the shaft 52 to allow selectively coupling one of the two planetary gear trains 53 and 54 to the forward-reverse gear selection mechanism 34. More specifically, the clutch 70 includes a movable disk 71 for selectively coupling with first and second fixed disks 73 and 75 respectively associated with the first or second ring gears 60 and 68. As such, the selected one of the first and second ring gears 60 and 68 together with movable disk 71 act as the output of the high-low gear selection mechanism 32. Of course, the three-position clutch 70 may also take the freewheeling position illustrated in FIG. 1.

***The person skilled in the art will now appreciate that the mechanism 32 being coupled to the CVT 16 downstream therefrom, it further transforms the original output of the prime mover 32 adding to the effect of the CVT 16. Therefore, the primary range of gear ratios provided by the CVT become a selected one of a high or low range of gear ratios downstream to the mechanism 32 when both the CVT 16 and mechanism 32 are coupled. Each of the high and low range of gear ratios is characterized by minimum and maximum values of respective range.

The power mixer 26 comprises a planetary gear train including a sun gear 38 coupled to the output disk 22 of the CVT 16, a ring gear 42 coupled to the final drive via the forward-reverse assembly 34, planet gears 40 coupled to both the sun gear 38 and ring gear 42 therebetween, and a planet carrier 44.

The sun gear 38 acts as a first input of the power mixer 26 and as such is connected via the shaft 47 to the output disk 22 of the CVT 16 via a gear set 46. The shaft 47 is shared by both mechanisms 26 and 32. Selected coupling of the CVT 16 with one of these two mechanisms 26 and 32 is achieved using the clutch 28 and 70, as will be described hereinbelow.

A gear set 48 is also provided between the planet carrier 44 and the second clutch 28 to complete the connection between the mixer 26 and the first clutch 15. The planet carrier 44 therefore acts as a second input of the power mixer 26.

Another gear set 50 is provided to connect the ring gear 42 to the shaft 52 which interconnects elements of the power mixer 26, high-low gear selection assembly 32 and forward-reverse gear selection assembly 34 as will be described hereinbelow in more detail. The ring gear 42 therefore acts as the output of the mixer 26.

As will be described in more detail hereinbelow with reference to the various modes of operation of the drivetrain 10, the power mixer 26 is adapted to receive inputs from the prime mover 12 and from the CVT 16 and to yield at the output, in cooperation with the CVT, a continuous mixed gear ratio. This continuous mixed gear ratio ranges between the maximum low gear ratio and the minimum high gear ratio described with reference to the high-low selection gear ratio. The power mixer 26 is therefore adapted to provide a seamless transition of continuous gear ratios between the low and high gear ratio ranges provided by the combination of the CVT 16 and the high-low gear selection mechanism 32.

Since forward-reverse gear selection assemblies are believed to be well-known in the art, and for concision purposes, the assembly 34 will only be briefly described herein.

The illustrated embodiment of the assembly 34 includes third and fourth clutches 73 and 74, each for selectively connecting the shaft 52 to the output shaft 76 via respective forward and reverse gear sets 78 and 80, causing the rotation of the final drive 36 in a same direction or in opposite direction of the input shaft 52 as it is well-known.

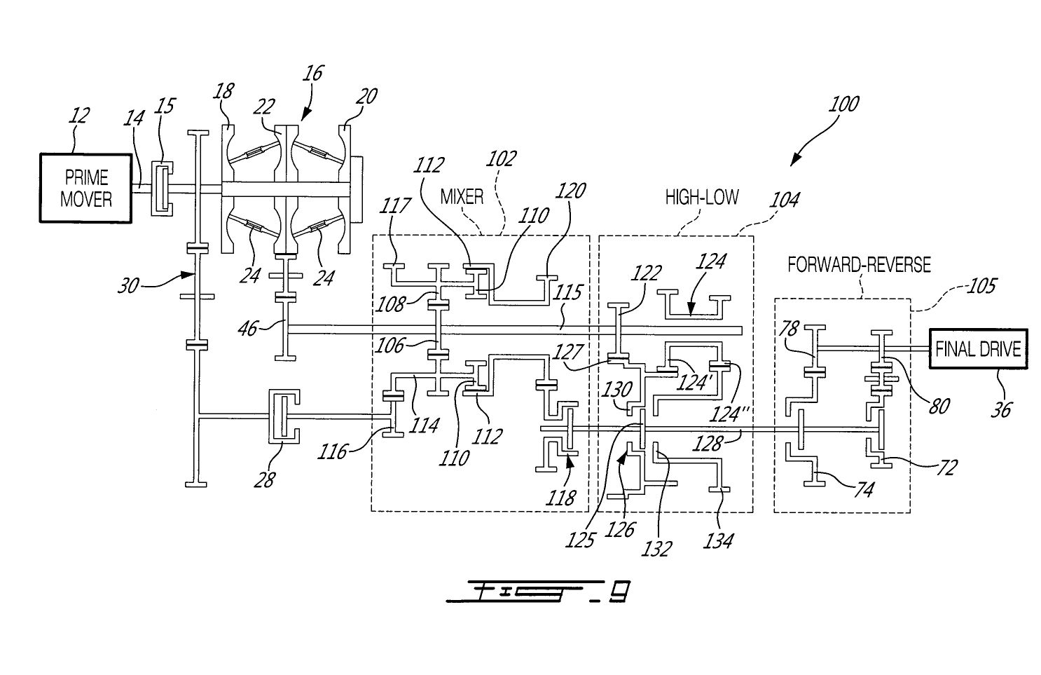

The drivetrain 10 is not limited to the illustrated embodiment 34 of a forward-reverse gear selection assembly as will become more apparent after reading the description of the second illustrated embodiment thereof with reference to FIG. 9 and following.

It is to be understood that the fixed and moveable disks schematically represent the many disks that insure clutching in conventional electro-hydraulically actuated wet clutches. Of course, other types of clutches, such as, for example dog clutches or electromagnetic clutches can be used. Furthermore, both clutches 73 and 74 could be replaced by a single three-position clutch (not shown).

It is to be noted that either the ratios of the low and high gear sets are selected in accordance to the intended use of the transmission 10. One skilled in the art will understand that the ratio of the low gear set ratio is greater than the ratio of the high gear set ratio.

The output shaft 76 is typically connected to the final drive 36, for example the differential of a vehicle.

It will be appreciated by one skilled in the art that the drivetrain 10 is only shown schematically in FIG. 1. Indeed, many required elements such as bearings, actuators and controller are not shown herein for clarity purpose.

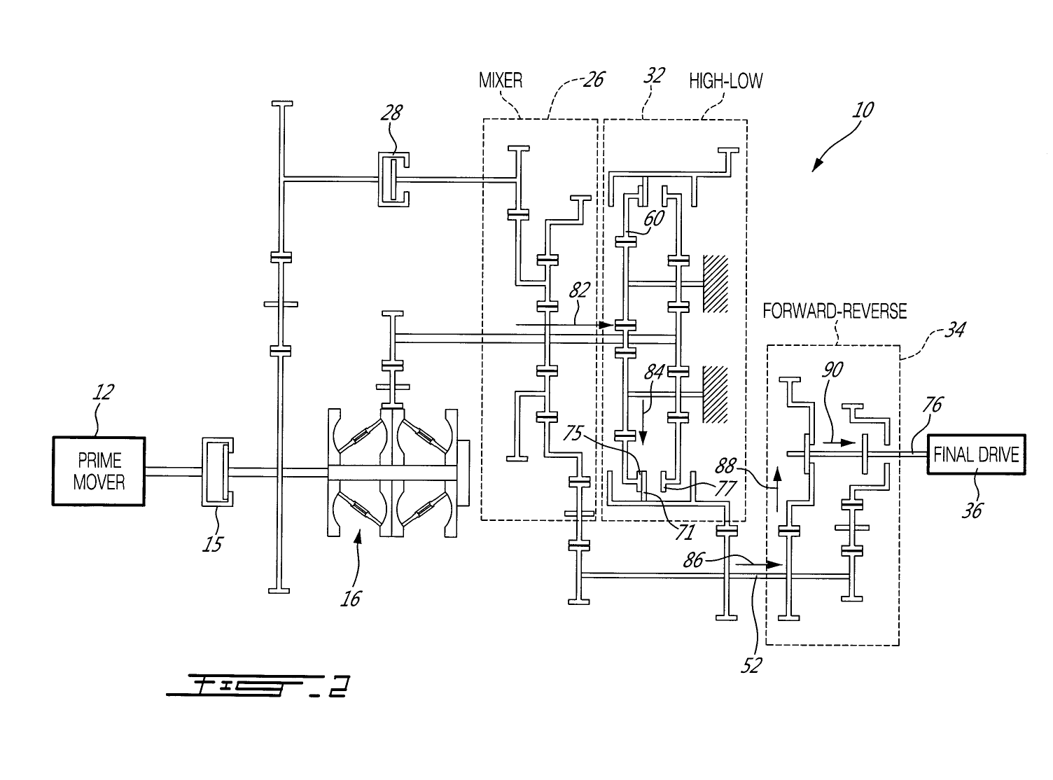

Turning now to FIGS. 2 to 8 of the appended drawings, the operation of the drivetrain 10 will be described. It is to be noted that in all mode of operations described hereinbelow, the first clutch 15 is engaged by the user when power is to be transferred from the prime mover 12 to the final drive 36.

FIG. 2 is a schematic bloc diagram of the drivetrain 10 shown in a CVT low configuration. Accordingly, the second clutch 28 is disengaged and power from the prime mover 12 goes to the high-low gear selection assembly 32 through the CVT 16 (see arrow 82).

The movable disk 71 of the clutch 70 is connected with the first fixed disk 73, thus to the ring gear 60 of the high-low gear selection assembly 32 (see arrow 84), such that the high-low gear assembly 32 is used to transfer torque to the shaft 52 (see arrow 86) of the forward-reverse gear selection assembly 34 in a low gear set configuration.

The forward-reverse gear selection assembly 34 being in the forward configuration (see arrow 88), the rotational power of the shaft 52 is directly transferred to the output shaft 76 (see arrow 90).

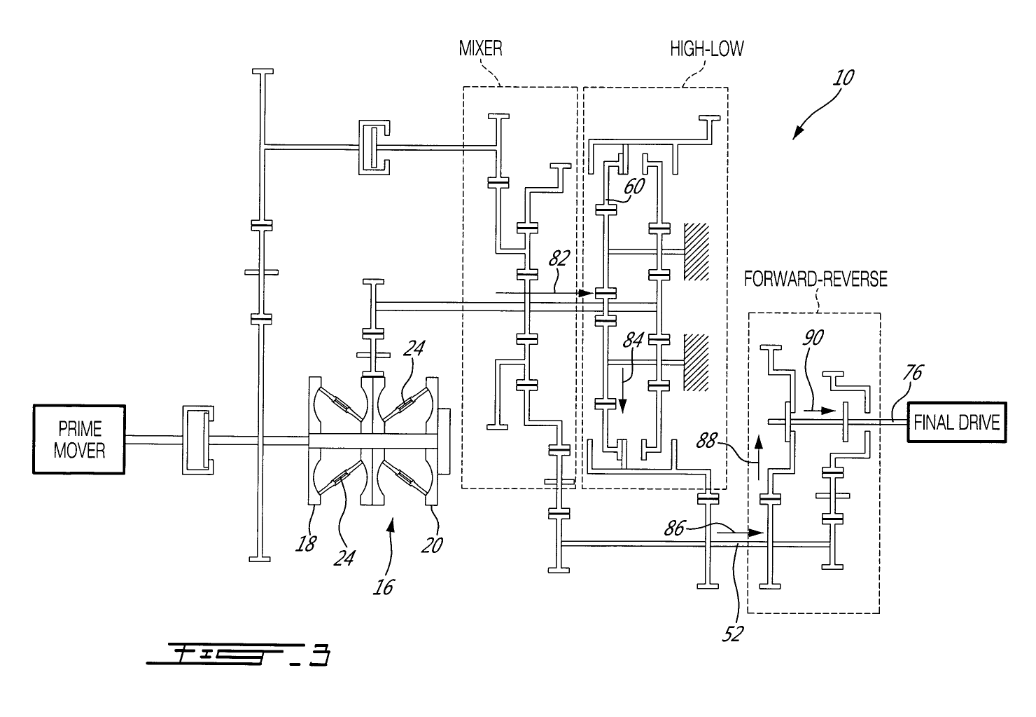

Assuming that the user desires to increase the speed of the vehicle, the position of the rollers 24 then gradually moves from the underdrive position shown in FIG. 2 to the overdrive position shown in FIG. 3. This directly causes the gradual increase of the speed of the first ring gear 60 and consequently of the shafts 52 and 76. FIG. 3 illustrates the configuration of the drivetrain 10 corresponding to the maximum speed of the CVT low configuration, i.e. when the CVT 16 is in its overdrive position.

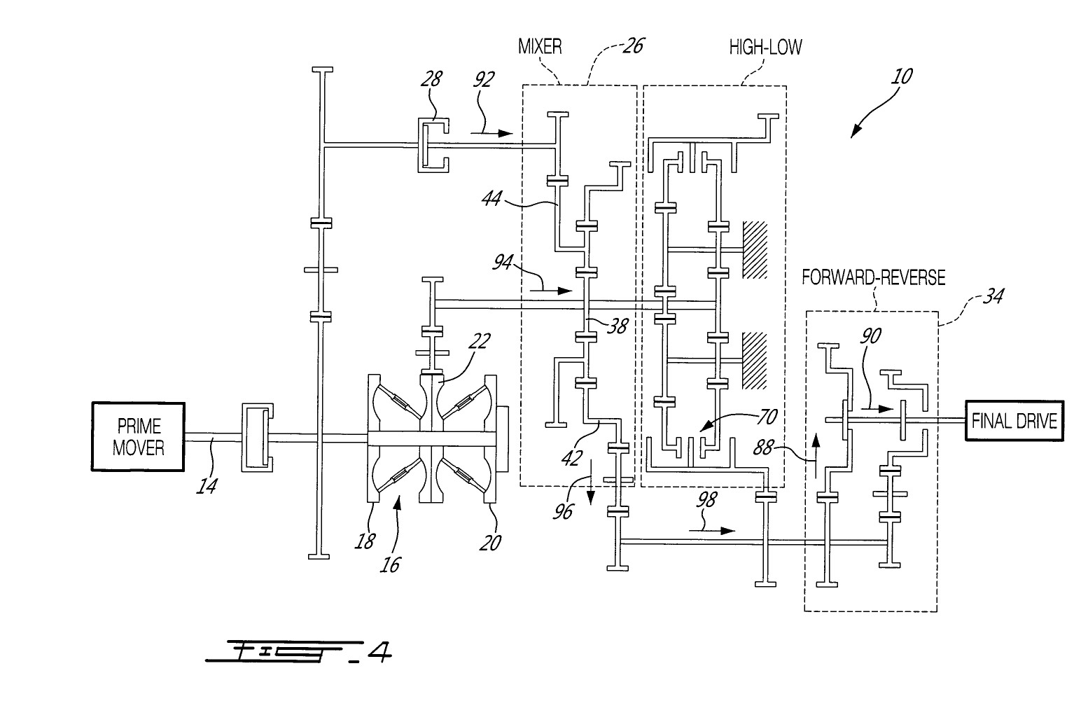

Turning now to FIG. 4, when such a maximum speed of the CVT low configuration is reached, the second clutch 28 is engaged, soliciting the mixer 26 and the clutch 70 is placed in its freewheeling position, placing the drivetrain 10 in an IVT configuration. Accordingly, the output shaft 14 is operatively coupled to both the input disks 18 and 20 of the CVT 16 and to the planet carrier 44 of the power mixer 26 (see arrow 92). The output disk 22 is operatively coupled to the sun gear 38 thereof (see arrow 94). The power is added in the power mixer 26 and transferred from the sun gear 38 and planet carrier 44 via the ring gear 42 (see arrow 96) to the forward-reverse gear selection assembly 34 (see arrow 98).

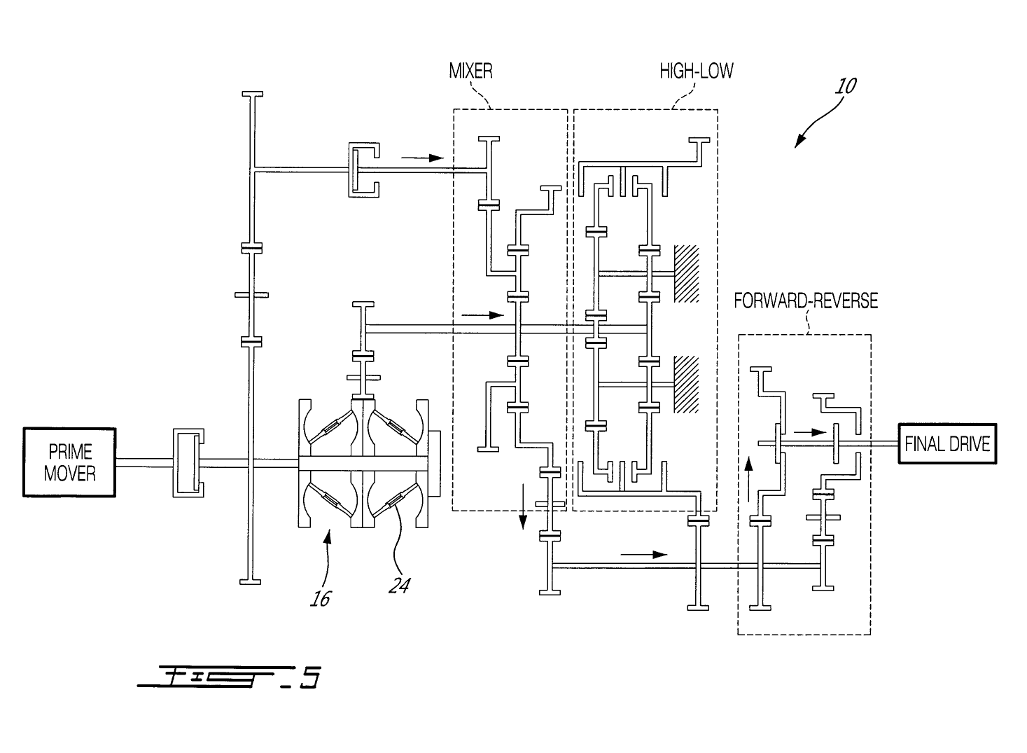

Again, assuming that the user desires to increase the speed of the vehicle, the position of the rollers 24 then gradually moves from the overdrive position shown in FIG. 4 to the underdrive position shown in FIG. 5. This corresponds to the maximum speed of the IVT configuration.

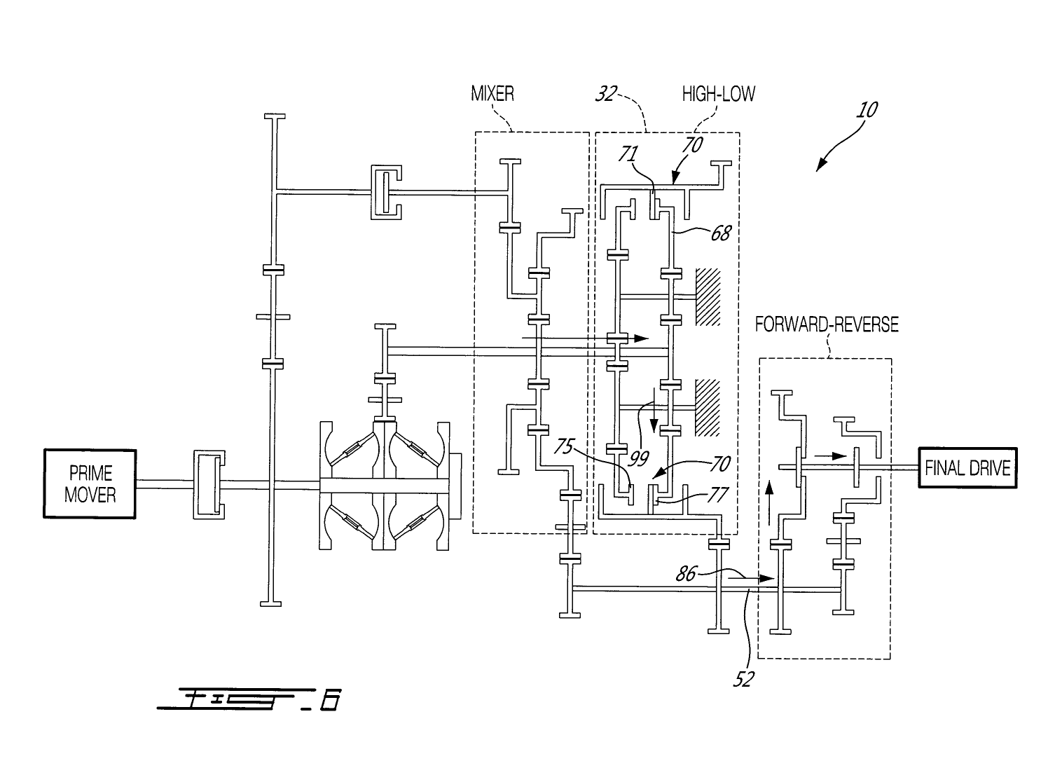

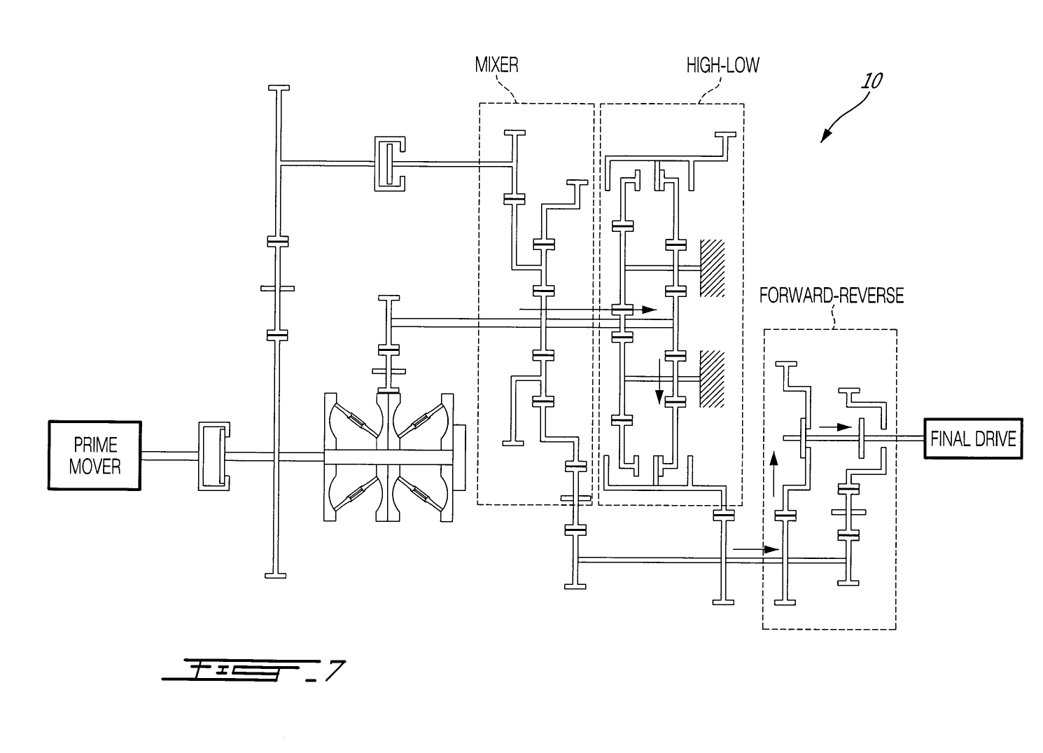

When the maximum speed of the IVT configuration is reached, the drivetrain moves to the CVT high configurations as illustrated in FIGS. 6 and 7. Since the CVT high configurations are very similar to the CVT low configurations described with references to FIGS. 2 and 3, only the differences between the CVT high and low configurations will now be described for concision purposes.

As a difference with the CVT low configuration, the movable disk 71 of the clutch 70 is connected with the second fixed disk 75 and thus to the ring gear 68 of the high-low gear selection assembly 32 (see arrow 99) such that the high-low gear assembly 32 is used to transfer torque to the shaft 52 (see arrow 86) of the forward-reverse gear selection assembly 34 in a high gear set.

Of course, should the user desire to increase speed, the position of the rollers is moved from the underdrive position illustrated in FIG. 6 to the overdrive position illustrates in FIG. 7. FIG. 7 illustrates the position of the various elements of the transmission at the maximal forward speed.

One skilled in the art will understand that the various ratios of the gear sets of the transmission 10 are so selected that the speed of the shaft 52 remains essentially the same when the transmission is moved from the CVT low configuration of FIG. 3 to the IVT configuration of FIG. 4. Similarly, the speed of the shaft 52 remains essentially the same when the transmission is moved from the IVT configuration of FIG. 5 to the CVT high configuration of FIG. 6. Accordingly, the changes in configuration are not adversely felt by the user.

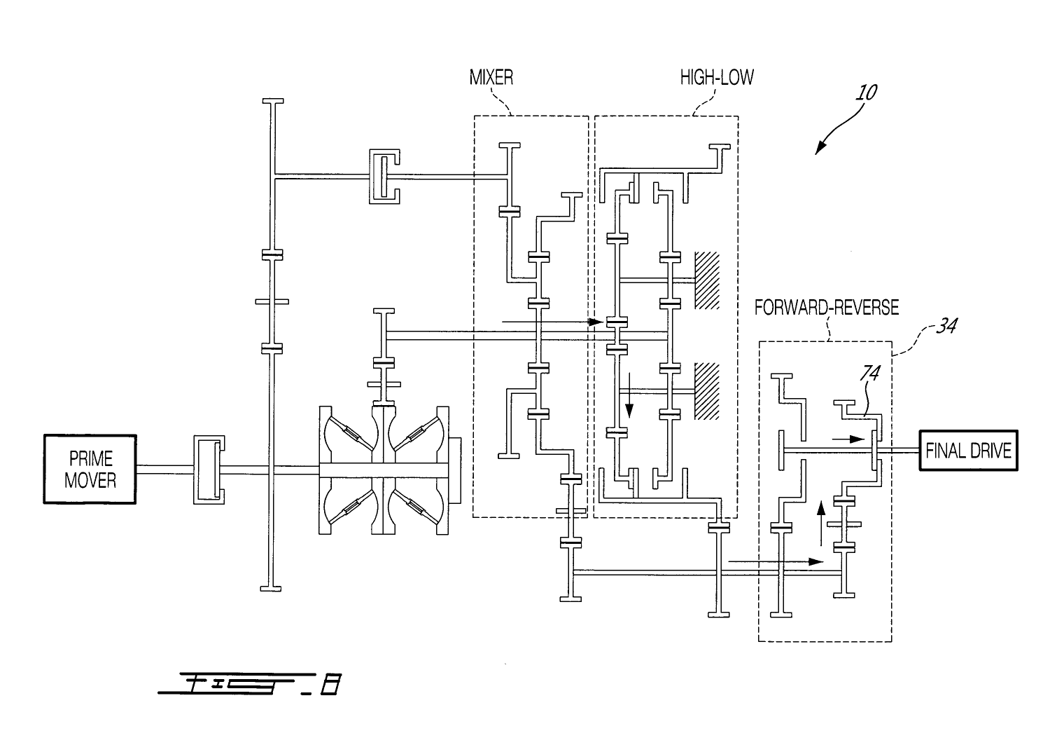

As can be seen with reference to FIG. 8, illustrating a further CVT configuration of the drivetrain 10, all of the above-described configurations of the drivetrain 10 are available in reverse when the clutch 74 is engaged in the forward-reverse gear selection assembly 34.

Even though the inputs and outputs of the CVT 16, power mixer 26 and high-low gear selection mechanism 32 have been described with reference to the provided gear ratios, they could have been also described, characterized and compared in terms of shaft speed and/or torque. Correspondences between these parameters are believed to be well-known to the skilled technician and as such will not be described herein in more detail.

Turning now to FIGS. 9 to 16 of the appended drawings, a drivetrain 100 according to a second illustrative embodiment will be described. Since the drivetrain 100 is very similar to the drivetrain 10 described hereinabove and illustrated in FIGS. 1 to 8, only the differences therebetween will be described hereinbelow for concision purpose.

Similarly to the drivetrain 10, the drivetrain 100 comprises a power mixer 102 coupled to both the prime mover 12 and the CVT 16 downstream therefrom, a high-low gear selection mechanism 104 coupled to the prime mover 12 downstream therefrom, and a forward-reverse gear selection assembly 105 coupled to both power mixer 102 and high-low gear selection mechanism 104 downstream therefrom and to the final drive 36 upstream therefrom.

Generally stated, the differences between the drivetrains 10 and 100 are related to the power mixer 102 and to the high-low gear selection assembly 104. The elements of the drivetrain 100 upstream from the power mixer 102 are identical to the ones of the power train 10 and identically numbered.

The power mixer 102 includes a planetary gear train including a sun gear 106, first and second planet gears 108 and 110, a ring gear 112 coupled to the second planet gears 110, and a planet carrier 114.

The sun gear 106, which acts as a first power input for the power mixer 102, is connected to the output disk 22 of the CVT 16 via a gear set 46 through a main shaft 115 which is further connected to the gear 122 of the high-low gear selection assembly 104.

The planetary gear train is coupled to the gear set 30 via its planet carrier 114, which is associated with a gear 117 meshed with gear 116 associated with the gear set 30. The planet carrier 114 defines the second input of the power mixer 102.

As can be seen from FIG. 9, the planet carrier 114 interconnects the planet gears 108, 110 and the gear 117.

The power mixer 102 further includes a second clutch 118 coupled to the ring gear 112 via a gear set 120.

The high-low gear selection mechanism 104 includes a single gear 122 and a double-ratio gear 124, having a first gear ratio 124′ and a second gear ratio 124″. The gear 122 is connected to the output disk 22 through the shaft 115.

The high-low gear selection assembly 104 further includes a clutch assembly including a three-position clutch 126 having a movable disk 125 mounted on the same shaft 128 than the clutch 118. The clutch assembly further including a coupling gear 127 to connect the first gear ratio 124′ of the double-ratio gear 124 to the single gear 122. The coupling gear 127 is connected with a first fixed disk 130 of the clutch 126. The second gear ratio 124″ of the double-ratio gear 124 is connected to a second fixed disk 132 of the clutch 126 via another gear 134.

The shaft 115 is shared by both mechanisms 102 and 104. Selected coupling of the CVT 16 with one of these two mechanisms 102 and 104 is achieved using the clutch 28, 118 and 125.

Selection between the low and high gear sets of the high-low gear selection mechanism 104 is achieved by positioning the three-position clutch 126 so that shaft 128 is coupled respectively to both the first gear ratio 124′ of the double-ratio gear 124 and the single gear 122 or to the second gear ratio 124″ of the double-ratio gear 124.

The forward-reverse gear selection assembly 105 is similar to the assembly 34 described with reference to FIG. 1, with, as a difference, that the shaft of the final drive 36 is mounted to the forward and reverse gear sets 78 and 80 and not to the clutches 72 and 74. As a person skilled in the art will appreciate, the forward-reverse gear selection assembly 105 will yield similar results in operation than the assembly 34 described with reference to FIG. 1.

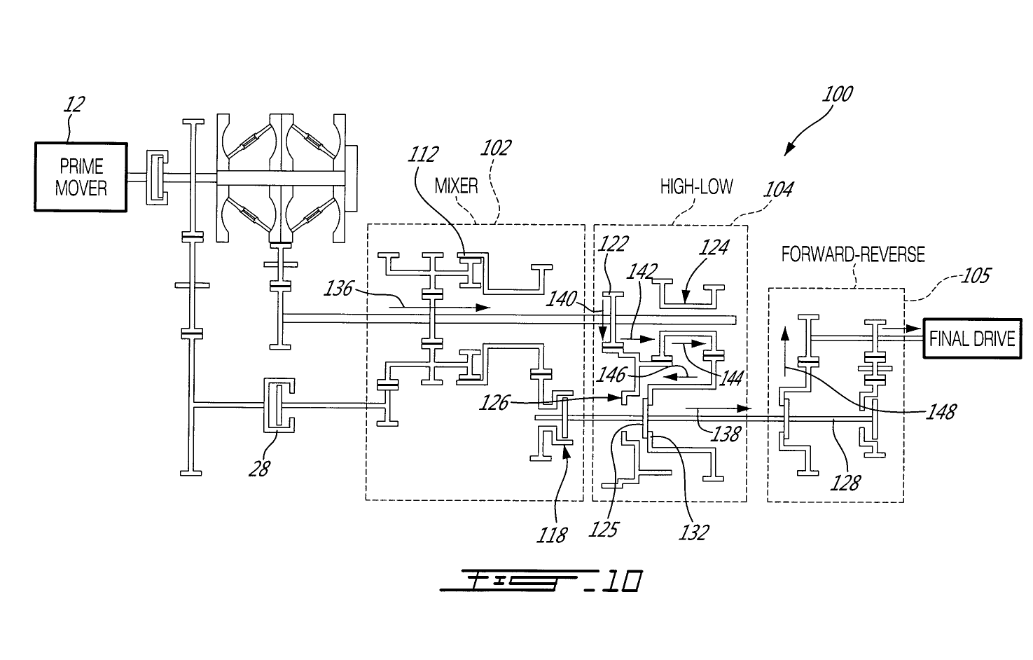

The operation of the drivetrain 100 will now be described with reference to FIGS. 10 to 16. It is to be noted that in all mode of operations described hereinbelow the first clutch 15 is engaged by the user when power is to be transferred from the prime mover 12 to the final drive 36.

FIG. 10 is a schematic bloc diagram of the drivetrain 100 shown in a CVT low configuration. Accordingly, the second clutch 118 is disengaged allowing the ring gear 112 to be freewheeling. Accordingly power from the prime mover 12 goes directly to the high-low gear selection assembly 104 through the CVT 16 (see arrow 136).

In the assembly 104, the movable disk 125 of the clutch 126 is engaged with the second fixed disk 132 so that the power from the main shaft 115 is transmitted from the power mixer 102 to the shaft 128 (see arrow 138) through the single and double ratio gears 122 and 124 (see arrows 140-146) providing a low gear ratio.

Power is then transmitted to the forward-reverse gear selection assembly 105 where the forward drive configuration is selected (see arrow 148).

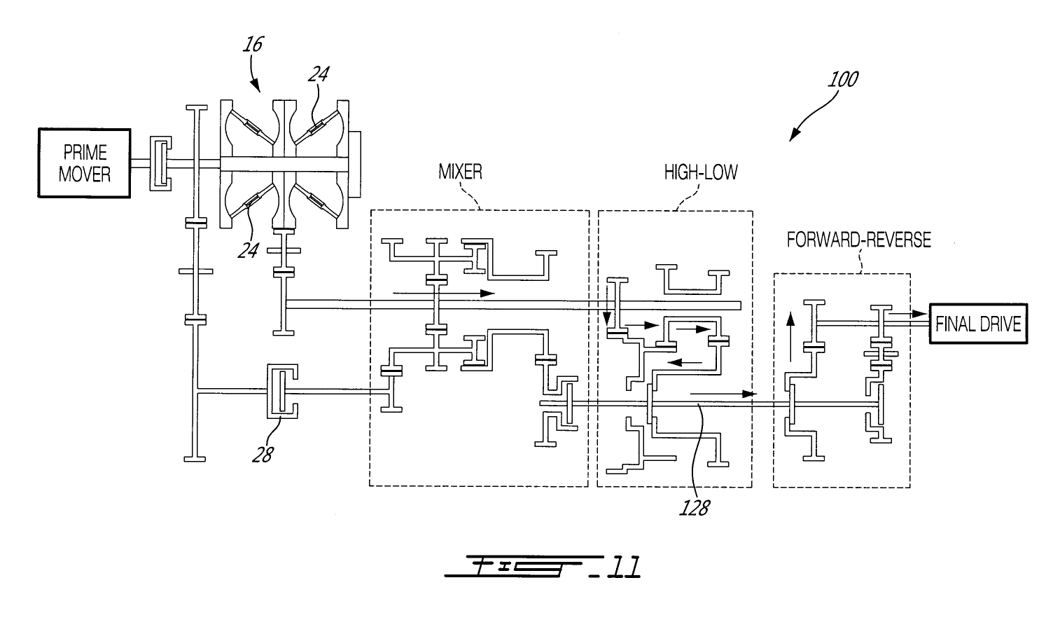

Assuming that the user desires to increase the speed of the vehicle, the position of the rollers 24 then gradually moves from the underdrive position shown in FIG. 10 to the overdrive position shown in FIG. 11. FIG. 11 illustrates the configuration of the drivetrain 100 corresponding to the maximum speed of the CVT low configuration.

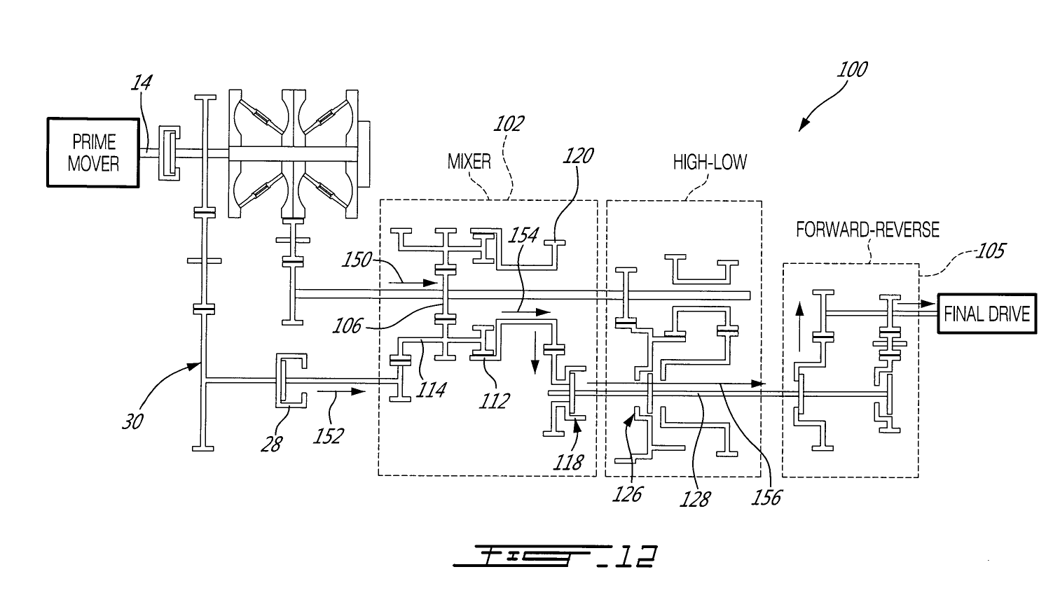

One skilled in the art will understand that the various ratios of the gear sets of the transmission 100 are so selected that the speed of the shaft 128 remains essentially the same when the transmission is moved from the CVT low configuration of FIG. 11 to the IVT configuration of FIG. 12.

Turning now to FIG. 12, when such a maximum speed of the CVT low configuration is reached, the second clutch 118 is engaged, soliciting the mixer 102, the clutch 126 is placed in its freewheeling position and the drivetrain 100 enters an IVT configuration. Accordingly, power from the prime mover 12 is transferred both to the sun 106 from the CVT 16 (see arrow 150) and to the planet carrier 114 from the gear set 30 (see arrow 152). The power from both sources is added in the mixer 102 and transferred through the ring gear 112 and the gear set 120 (see arrow 154) directly to the forward-reverse gear selection assembly 105 by the engagement of the second clutch 118 (see arrow 156).

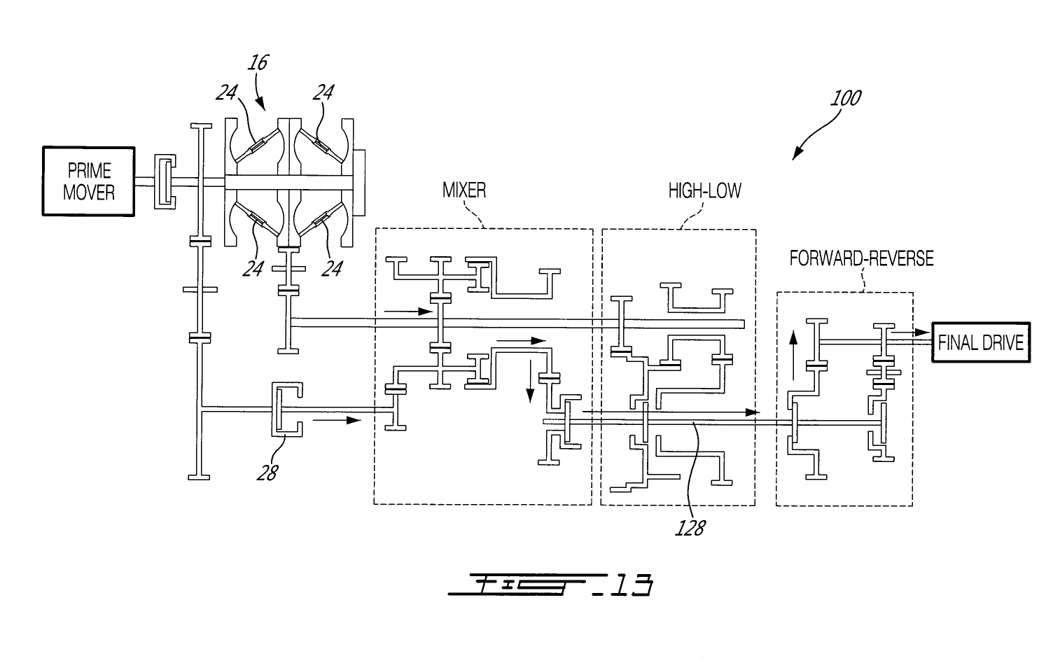

Again assuming that the user desires to increase the speed of the vehicle, the position of the rollers 24 then gradually moves from the overdrive position shown in FIG. 12 to the underdrive position shown in FIG. 13. This corresponds to the maximum speed of the IVT configuration.

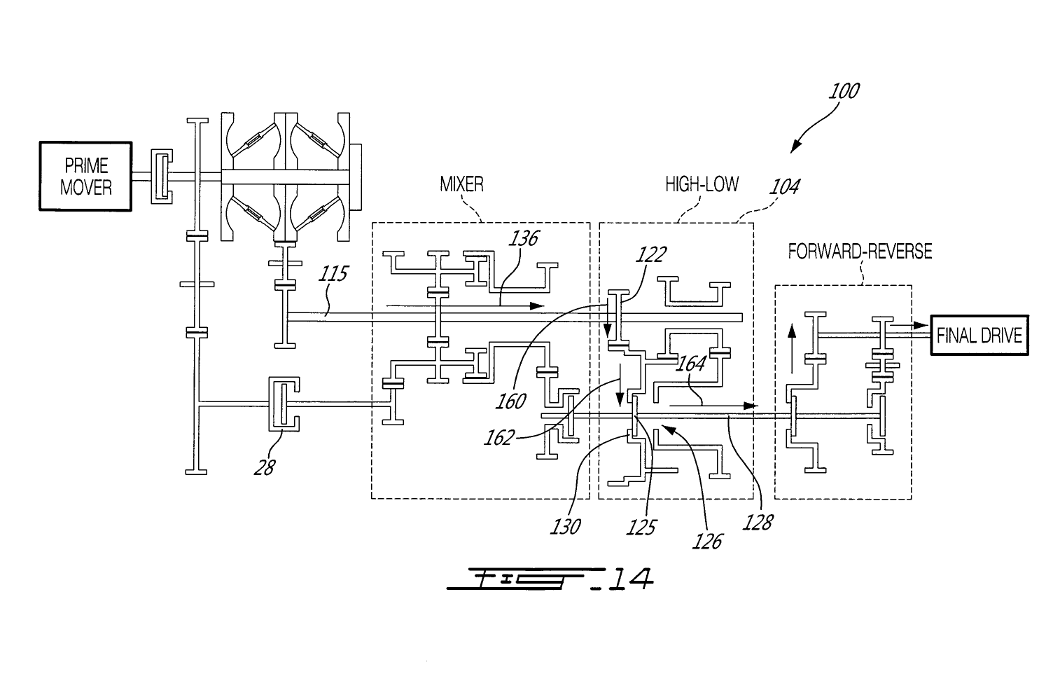

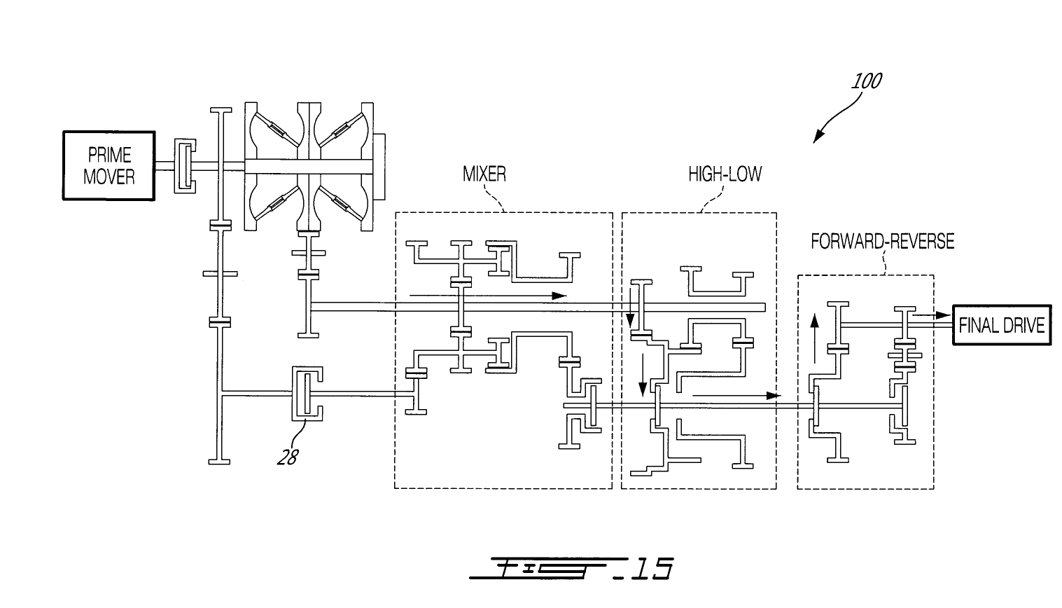

When the maximum speed of the IVT configuration is reached, the drivetrain moves to the CVT high configurations as illustrated in FIGS. 14 and 15. Since the CVT high is very similar to the CVT low configurations described with references to FIGS. 10 and 11, only the differences between the CVT high and low configurations will now be described for concision purposes.

Again, one skilled in the art will appreciate that the various ratios of the gear sets of the transmission 100 are so selected that the speed of the shaft 128 remains essentially the same when the transmission is moved from the IVT configuration of FIG. 13 to the CVT high configuration of FIG. 14.

As a difference with the CVT low configuration, the movable disk 125 of the clutch 126 is engaged with the first fixed disk 130 so that the power from the main shaft 115 is transmitted from the power mixer 102 to the shaft 128 (see arrow 164) through the single gear 122 (see arrow 160), then through the clutch 126 (see arrow 162) an providing a high gear ratio.

Of course, should the user desire to increase speed, the position of the rollers is moved from the underdrive position illustrated in FIG. 14 to the overdrive position illustrates in FIG. 15. FIG. 15 illustrates the position of the various elements of the transmission at the maximal forward speed.

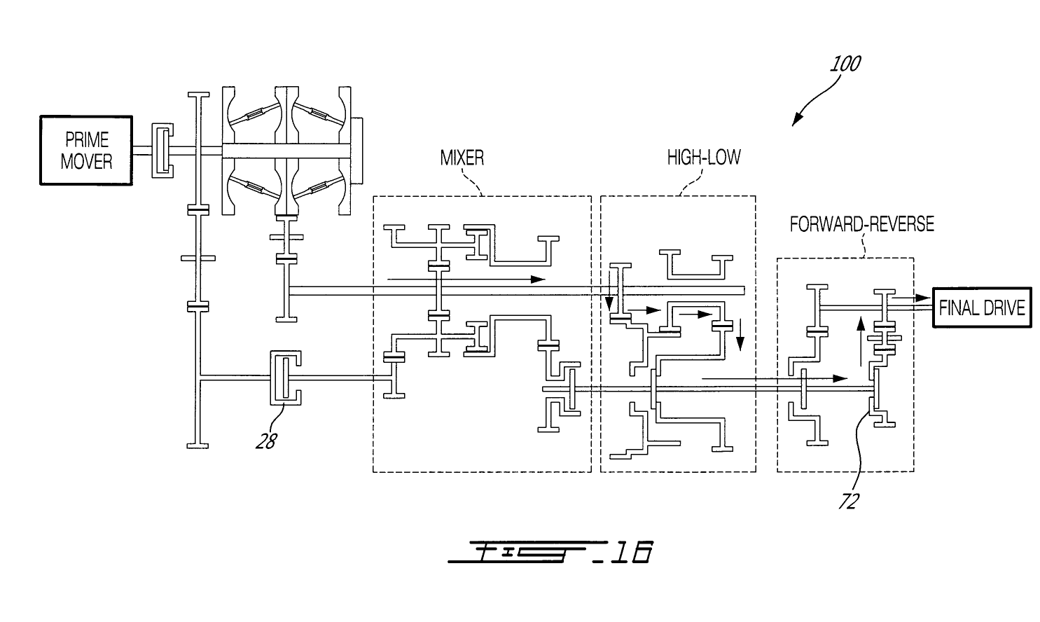

As can be seen with reference to FIG. 16, illustrating a further CVT configuration of the drivetrain 100, all of the above-described configuration of the drivetrain 100 are available in reverse when the clutch 72 is engaged in the forward-reverse gear selection assembly 105.

According to a more specific embodiment, the prime mover 12 is the motor of a tractor (not shown) and the various gear set configuration changes described hereinabove are achieved by pressing and depressing the accelerator pedal (not shown). Of course, a drivetrain according to an illustrative embodiment is not limited to this application.

The prime mover 12 can be in the form of an engine, a turbine, an electric motor, etc.

One skilled in the art will understand that the entire range of speed of the drivetrain 100 has been spanned without changing the speed of the prime mover 12 and without noticeable surges to the operator.

One skilled in the art is believed to be in a position to design or to select appropriate parts of the drivetrain depending on the required maximal speed and torque required for a specific application.

One skilled in the art will understand that while a dual cavity toroidal CVT has been illustrated herein, other CVT technologies could be used.

It is also to be noted that while clutches are described above to selectively interconnect various components of the drivetrain according to the above-described embodiments, one skilled in the art would be in a position to design other clutching arrangements to interconnect these elements with the same functionality.

One skilled in the art will understand that the various clutches described herein can use any clutch technology. For example, the clutches could be jaw clutches, magnetic clutches or hydraulic clutches. Of course, the various clutches do not need to be of the same type.

As will be apparent to one skilled in the art, the CVT 16 could be so connected to the other elements that the disk 22 is an input disk and the disks 18 and 20 are output disks.

It is to be understood that the drivetrain provided with a CVT is not limited in its applications to the details of construction and parts illustrated in the accompanying drawings and described hereinabove. The drivetrain provided with a CVT is capable of other embodiments and of being practiced in various ways. It is also to be understood that the phraseology or terminology used herein is for the purpose of description and not limitation. Hence, although the drivetrain provided with a CVT has been described hereinabove by way of illustrative embodiments thereof, it can be modified, without departing from the spirit, scope and nature of the subject invention.

What is claimed is:

1. A drivetrain for connection to the output of a prime mover and to the input of a final drive therebetween; the drivetrain comprising:
a CVT (Continuous Variable Transmission) including an input disk coupled to the output of the prime mover and an output disk; the CVT being adapted to provide between the input and output thereof a primary continuous range of gear ratios;
a high-low gear selection mechanism having an input coupled to the output disk of the CVT and an output coupled to the input of the final drive; the high-low gear selection mechanism being adapted to selectively provide, in cooperation with the CVT, one of low and high continuous ranges of gear ratios between the output of the prime mover and the input of the final drive; the low continuous range of gear ratio ranging between minimum and maximum low gear ratios; the high continuous range of gear ratio ranging between minimum and maximum high gear ratios; and
a power mixer having a first input coupled to the output of the prime mover, a second input coupled to the output disk of the CVT and an output coupled to the input of the final drive; the power mixer being adapted to provide, in cooperation with the CVT, a continuous mixed gear ratio ranging between the maximum low gear ratio and the minimum high gear ratio between the output of the prime mover and the input of the final drive.

2. A drivetrain as recited in claim 1, wherein the high-low gear selection mechanism includes first and second planetary gear trains providing, in cooperation with the CVT, respectively the low and high continuous ranges of gear ratios.

3. A drivetrain as recited in claim 2, wherein the first and second planetary gear trains share a fixed planet carrier; the first planetary gear train further including a first sun gear, a first ring gear and first planet gears; the second planetary gear train further including a second sun gear, a second ring gear and second planet gears; the first and second sun gears being coupled to the output disk of the CVT.

4. A drivetrain as recited in claim 3, wherein the high-low gear selection mechanism further includes a clutch assembly provided between i) both the first and second ring gears and ii) the input of the final drive, to allow selectively coupling one of the two planetary gear trains to the final drive.

5. A drivetrain as reciting in claim 1, wherein the high-low gear selection mechanism includes single and double-ratio gears, both coupled to the output disk of the CVT and yielding respectively first and second gear ratio outputs; one of the first and second gear ratio outputs of the double-ratio gear providing, in cooperation with the CVT, one of the low and high continuous ranges of gear ratios; the other of the first and second gear ratio outputs of the double-ratio gear providing, in cooperation with both the CVT and the single gear, the other of the low and high continuous ranges of gear ratios.

6. A drivetrain as recited in claim 5, wherein the high-low gear selection mechanism further includes a clutch assembly provided between i) both the single gear and the double-ratio gear and ii) the input of the final drive, to allow selectively coupling either a) together the single gear and the first gear ratio output of the double-ratio gear and b) the second gear ratio of the double-ratio gear to the final drive.

7. A drivetrain as recited in claim 1, wherein the power-mixer includes a planetary gear train.

8. A drivetrain as recited in claim 7, wherein the planetary gear train includes a sun gear coupled to the output disk of the CVT, a ring gear coupled to the final drive, planet gears mounted to both the sun gear and ring gear therebetween and a planet carrier coupled to the prime mover.

9. A drivetrain as recited in claim 7, wherein the planetary gear train includes a sun gear coupled to the output disk of the CVT, a planet carrier coupled to the prime mover, a ring gear coupled to the final drive, and first and second planet gears mounted to both the sun and ring gear.

10. A drivetrain as reciting in claim 1, further comprising a double-position clutch assembly coupled to the power-mixer, to the high-low gear selection mechanism and to the final drive for selectively coupling one of the power-mixer and high-low gear selection mechanism to the final drive.

11. A drivetrain as reciting in claim 1, further comprising a main shaft for connecting to the output disk of the CVT the inputs of both the high-low gear selection mechanism and the power-mixer.

12. A drivetrain as reciting in claim 1, further comprising a forward-reverse gear selection assembly having an input coupled to the outputs of both the high-low gear selection mechanism and of the power mixer and an output coupled to the input of the final drive.

13. A drivetrain as reciting in claim 1, further comprising a first clutch coupled to the output of the prime mover, to the input disk of the CVT and to the input of the power mixer for causing power transfer from the prime mover to the drivetrain.

14. A drivetrain as reciting in claim 13, wherein the first input of the power mixer is coupled to the first clutch downstream thereof via a second clutch coupled to a first gear set.

15. A drivetrain as recited in claim 1, wherein the prime mover is selected from a group consisting of an engine, a turbine and an electric motor.

16. A drivetrain as recited in claim 1, wherein the CVT is a toroidal CVT.

17. A drivetrain as recited in claim 16, wherein the toroidal CVT is a dual cavity toroidal CVT.
